(19) United States
(12) Patent Application Publication
(10) Pub. No.: US 2008/0065754 A1
(43) Pub. Date: Mar. 13, 2008

(54) System And Method For Dynamic Picture Generation In A Web Or Java Application

(76) Inventors: Linda V. Benhase, Tucson, AZ (US); Ashaki A. Ricketts, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/465,329

(22) Filed: Aug. 17, 2006

(51) Int. Cl. G06F 15/173

(52) U.S. Cl. 709/224

(57) ABSTRACT

A system, computer-implementable method, and computer-usable medium for dynamic picture generation. In a preferred embodiment of the present invention, a properties manager receives a collection of properties for a computer system and constructing an graphical representation of said computer system by retrieving a collection of images corresponding to the collection of properties, organizing the collection of images with respect to a base coordinate, and instructing a diagram constructor to generate the graphical representation in response to organizing the collection of images.

### BACKGROUND OF THE INVENTION

1. Technical Field

The present invention relates in general to the field of data processing systems. More specifically, the present invention relates to a system and method for dynamic picture generation in a web or Java application.

2. Description of the Related Art

In today's product development process, it is desirable to provide a customer with a topological, pictorial representation of a computer system for problem solving purposes. However, since customers now have the flexibility to customize their systems, often, the general pictorial representation provided by the manufacturer differs from the actual configuration of a customer's system. Therefore, there is a need for a system and method to address the aforementioned limitations of the prior art.

### SUMMARY OF THE INVENTION

The present invention includes a system, computer-implementable method, and computer-usable medium for dynamic picture generation. In a preferred embodiment of the present invention, a properties manager receives a collection of properties for a computer system and constructing an graphical representation of said computer system by retrieving a collection of images corresponding to the collection of properties, organizing the collection of images with respect to a base coordinate, and instructing a diagram constructor to generate the graphical representation in response to organizing the collection of images.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary data processing system in which a preferred embodiment of the present invention may be implemented;

FIG. 2 is a block diagram depicting exemplary contents of a system memory in which a preferred embodiment of the present invention may be implemented;

FIG. 3 is a high-level logical flowchart diagram illustrating an exemplary method for dynamic picture generation in a web or java application; and

FIG. 4 is a pictorial representation of a composite diagram generated by a diagram constructor according to a preferred embodiment of the present invention.

### DETAILED DESCRIPTION OF A PREFERRED EMBODIMENT

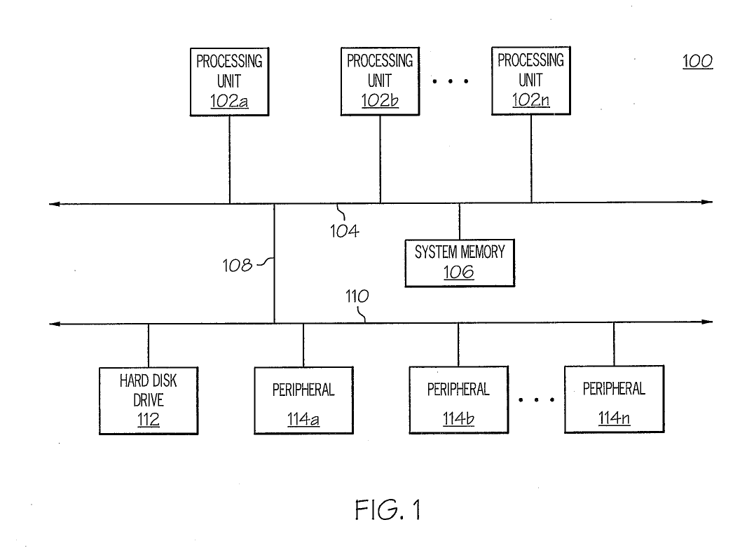

Referring to the figures, and more particularly, referring now to FIG. 1, there is illustrated a block diagram of an exemplary data processing system in which a preferred embodiment of the present invention may be implemented. As depicted, exemplary data processing system 100 includes processor(s) 102a-n, which are coupled to system memory 106 via system bus 104. Preferably, system memory 106 may be implemented as a collection of dynamic random access memory (DRAM) modules. Mezzanine bus 108 acts as an intermediary between system bus 104 and peripheral bus 110. Those with skill in this art will appreciate that peripheral bus 110 may be implemented as a peripheral component interconnect (PCI), accelerated graphics port (AGP), or any other peripheral bus. Coupled to peripheral bus 110 is hard disk drive 112, which is utilized by data processing system 100 as a mass storage device. Also coupled to peripheral bus 110 is a collection of peripherals 114a-n.

Those skilled in the art will appreciate that data processing system 100 can include many additional components not specifically illustrated in FIG. 1. Because such additional components are not necessary for an understanding of the present invention, they are not illustrated in FIG. 1 or discussed further herein. It should also be understood, however, that the enhancements to data processing system 100 for dynamic picture generation provided by the present invention are applicable to data processing systems of any system architecture and are in no way limited to the generalized multi-processor architecture or symmetric multi-processing (SMP) architecture illustrated in FIG. 1.

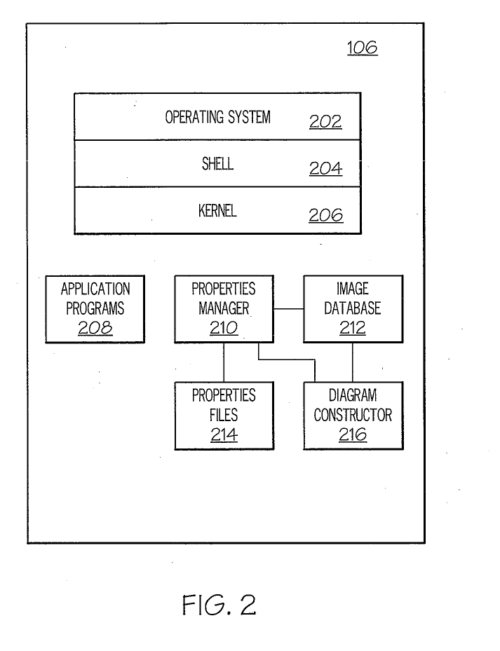

FIG. 2 is a block diagram illustrating exemplary contents of system memory 106 of data processing system 100, according to a preferred embodiment of the present invention. As illustrated, system memory 106 includes operating system 202, which further includes shell 204 for providing transparent user access to resources such as application programs 208. Generally, shell 204 is a program that provides an interpreter and an interface between the user and the operating system. More specifically, shell 204 executes commands that are entered into a command line user interface or a file. Thus, shell 204 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 206) for processing. Note that while shell 204 is a text-based, line-oriented user interface, the present invention will support other user interface modes, such as graphical, voice, gestural, etc. equally well.

As illustrated, operating system 202 also includes kernel 206, which includes lower levels of functionality for operating system 202, including providing essential services required by other parts of operating system 202 and application programs 208, including memory management, process and task management, disk management, and mouse and keyboard management. Application programs 208 can include a browser, utilized for access to the Internet, word processors, spreadsheets, and other application programs. Also stored in system memory 106 are properties manager 210, image database 212, properties files 214, and diagram constructor 216, all discussed herein in more detail.

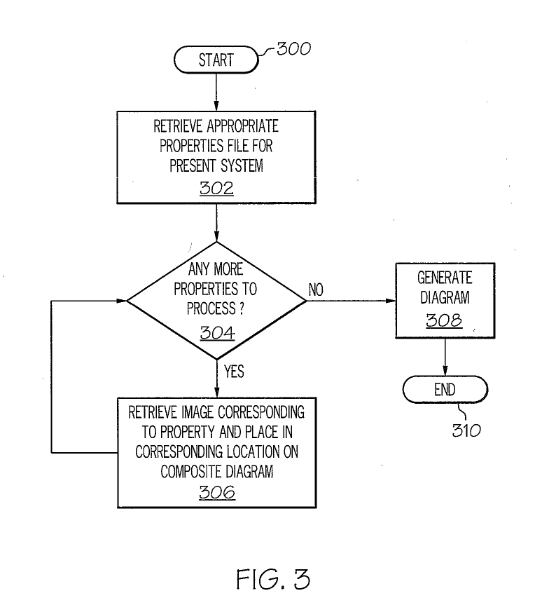

According to a preferred embodiment of the present invention, properties manager 210 retrieves an appropriate property file of a system to be examined from properties files 214 and plans a layout of the components within the system utilizing images from image database 212. Properties files 214 include attributes of various system configurations like the physical locations of hard disk drives, network adapters, processors and other system components. These system configurations are tailored to match the unique system configurations, regardless of the implementation of various systems. For example, the system configurations stored in properties files 214 may represent unique computer system configurations of different customers who have purchased the computer systems from a vendor. To facilitate maintenance and troubleshooting issues, it is desirable for a customer to have a graphical representation of their particular computer system. The system configurations stored in properties files 214 outline the unique configuration of user computer systems to enable diagram constructor 216 to generate a graphical diagram that illustrates a customer's unique computer system configuration. In a preferred embodiment of the present invention, properties manager 210 may access a customer's computer system via a network such as the Internet to read the current configuration of the customer's computer system and generate a system configuration to be stored in properties file 214 In another preferred embodiment of the, present invention, properties manager 210 may access a computer's computer system via a network, read the current configuration of the customer's computer system, and control the selection of images (discussed herein in more detail in conjunction with step 306 in FIG. 3) based on the current configuration of the customer's computer system.

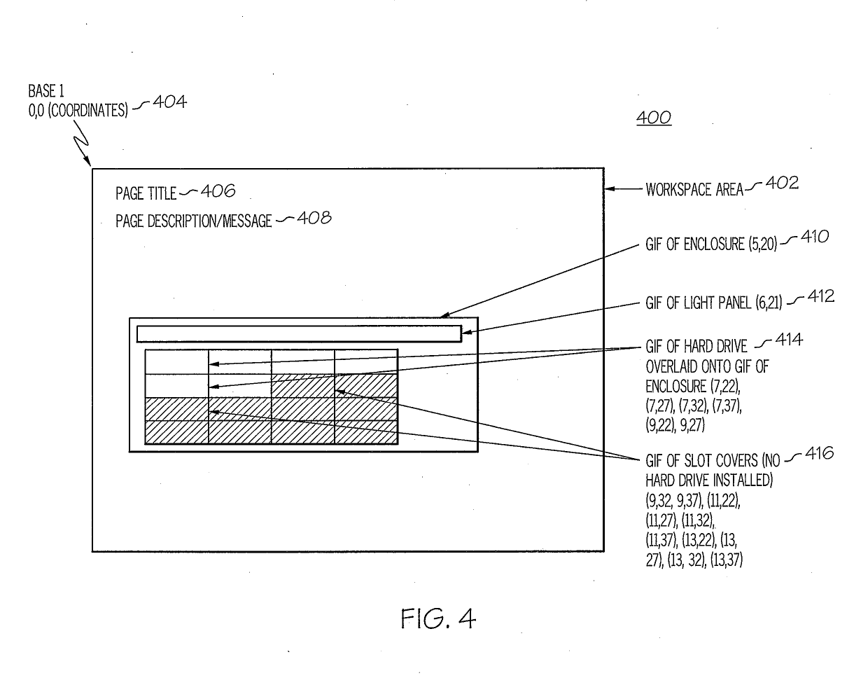

Diagram constructor 216 generates a diagram (e.g., FIG. 4) to be displayed on a display coupled to data processing system 100 that represents a graphical representation of a system whose properties are stored in properties files 214.

FIG. 3 is a high-level flowchart diagram illustrating an exemplar method for implementing dynamic picture generation in a web of Java application according to a preferred embodiment of the present invention. The process begins at step 300 and proceeds to step 302, which illustrates properties manager 210 retrieving an appropriate properties file corresponding to a particular system configuration from properties files 214. As previously discussed, properties manager 210 may also access a customer's computer system via a network such as the Internet to retrieve a particular system configuration. The process continues to step 304, which illustrates properties manager 210 determining if there are any other remaining properties to process. If not, the process proceeds to step 308, which illustrates diagram constructor 216 generating a diagram mapped by properties manager 210. The process then ends, as illustrated by step 310. If so, the process continues to step 306, which illustrates properties manager 210 retrieving an image from image database 212 that corresponds to a property in the properties file and placing mapping the image to a corresponding location on the composite diagram. The process returns to step 304 and continues in an iterative fashion.

FIG. 4 is a graphical depiction of a composite diagram 400 generated by diagram constructor 216 according to a preferred embodiment of the present invention. As illustrated, composite diagram 400 includes workspace area 402, base coordinates 404, page title 406, page description 408, and a collection of gif images 410-416. During the process described in conjunction with FIG. 3, properties manager 210 retrieves the appropriate properties file from properties files 214 that corresponds to a certain system configuration. Utilizing the base coordinates, properties manager 210 maps out the locations of various images, based on the properties found in the properties file. For example, the image corresponding to the system enclosure is mapped to coordinates (5, 20). The image corresponding to the light panel is mapped to coordinates (6, 21). When properties manager 210 has processed all of the properties in the file, diagram constructor 216 retrieves the images corresponding to the mapped properties from image database 212 and constructs a composite diagram (e.g., composite diagram 400).

As discussed, the present invention includes a system, computer-implementable method, and computer-usable medium for dynamic picture generation. In a preferred embodiment of the present invention, a properties manager receives a collection of properties for a computer system and constructing an graphical representation of said computer system by retrieving a collection of images corresponding to the collection of properties, organizing the collection of images with respect to a base coordinate, and instructing a diagram constructor to generate the graphical representation in response to organizing the collection of images.

It should be understood that at least some aspects of the present invention may alternatively be implemented as a program product. Program code defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to Random Access Memory (RAM), and communication media, such as computer and telephone networks including Ethernet, the Internet, wireless networks, and like network systems. It should be understood, therefore, that such signal-bearing media when carrying or encoding computer-readable instructions that direct method functions in the present invention represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method comprising:
receiving a collection of properties for a computer system; and
constructing a graphical representation of said computer system by:
retrieving a plurality of images corresponding to said collection of properties;
organizing said plurality of images with respect to a base coordinate; and
generating said graphical representation in response to said organizing.

2. The computer-implementable method according to claim 1, wherein said graphical representation is a graphical representation of a unique user computer system configuration.

3. The computer-implementable method according to claim 1, wherein said receiving further comprises:
retrieving said collection of properties for a computer system via a network connection.

4. A system comprising:
a processor;
a databus coupled to said processor; and
a computer-usable medium embodying computer program code, said computer-usable medium being coupled to said databus, said computer program code comprising instructions executable by said processor and configured for:
receiving a collection of properties for a computer system; and
constructing a graphical representation of said computer system by:
retrieving a plurality of images corresponding to said collection of properties;
organizing said plurality of images with respect to a base coordinate; and
generating said graphical representation in response to said organizing.

5. The system according to claim 4, wherein said graphical representation is a graphical representation of a unique user computer system configuration.

6. The system according to claim 4, wherein said instructions for receiving are further configured for:
retrieving said collection of properties for a computer system via a network connection.

7. A computer-usable medium embodying computer program code, said computer program code comprising computer-executable instructions configured for:
receiving a collection of properties for a computer system; and
constructing a graphical representation of said computer system by:
retrieving a plurality of images corresponding to said collection of properties;
organizing said plurality of images with respect to a base coordinate; and
generating said graphical representation in response to said organizing.

8. The computer-usable medium embodying computer program code according to claim 7, wherein said graphical representation is a graphical representation of a unique user computer system configuration.

9. The computer-usable medium embodying computer program code according to claim 7, wherein said computer program code comprising computer-executable instructions for receiving are further configured for:
retrieving said collection of properties for a computer system via a network connection.
